(19) United States
(12) Patent Application Publication
(10) Pub. No.: US 2003/0159483 A1
(43) Pub. Date: Aug. 28, 2003

(54) Rekeyable mortise lock

(76) Inventors: Michael W. Kondratuk, Cameron, WI (US); Kevin Anibas, Eau Claire, WI (US); Gerald R. Bowe, Eau Claire, WI (US); Holly Chen, Rice Lake, WI (US)

Correspondence Address: MERCHANT & GOULD PC, P.O. BOX 2903, MINNEAPOLIS, MN, 55402-0903, US

(21) Appl. No.: 10/281,400

(22) Filed: Oct. 25, 2002

Related U.S. Application Data
(63) Continuation-in-part of application No. 10/193,690, filed on Jul. 10, 2002, now abandoned.
Application No. 10/193,690 is a continuation-in-part of application No. 10/012,716, filed on Nov. 5, 2001.

(51) Int. Cl. E05B 27/04

(52) U.S. Cl. 70/493

(57) ABSTRACT

A lock apparatus includes a housing having a cylindrical bore formed therein and a cam rotatably mounted in the housing. A cylindrical sleeve having a notch formed therein rotatably mounts in the bore of the housing. A cylinder core inserts into the sleeve and engages the cam. The core including multiple tumblers and the housing has a corresponding number of drivers biased toward the bore and engaging the tumblers through the notch and aligned along the periphery of the bore when a proper key is inserted. When the sleeve is rotated, the drivers are captured in their bores, allowing the core to be easily removed without a tube or special tools and providing for simple rekeying.

### CROSS-REFERENCE

This application is a continuation-in-part of U.S. application Ser. No. 10/193,690, filed on Jul. 10, 2002, which is a continuation-in-part of Ser. No. 10/012,716, filed on Nov. 5, 2001, which is herein incorporated by reference.

### BACKGROUND OF THE INVENTION

1. Field of the Invention

The present invention is directed to a rekeyable mortise lock, and in particular to a rekeyable mortise lock having a sleeve fitting over the core for capturing the drivers in the housing, with the core insertable into and removable from a first end of the lock housing.

2. Prior Art

Key actuated locks are well known and have been for many years. The locks are actuated by having a core with tumblers matching up to corresponding drivers in the housing that engage one another. When the proper key is inserted, the drivers and tumblers abut one another along the boundary between the core and the housing. This alignment allows the cylindrical core to rotate and actuate the lock. When an incorrect key is inserted, one or more of the drivers and/or tumblers extends across the boundary between the core and the housing so the core cannot rotate.

A common difficulty with such locks is rekeying. Rekeying may occur when security needs to be changed, as for example, when new owners or new tenants occupy residences. The tumblers and spring-loaded drivers are housed in bores formed within the core and housing, respectively. When the core is removed, the drivers are spring-loaded and may be flung from the lock and become lost if not captured in the housing. In addition, there is difficulty in placing the drivers and tumblers back within their respective bores and keeping the tumblers and drivers captured within the bore to prevent loss or misplacement.

A common method of rekeying involves the use of a tube inserting into the bore while the key core is removed. Although this method may be effective in retaining the drivers, it has other drawbacks. The insertion of the tube must be from the opposite end of the housing from which the key cylinder is removed. This requires modification of the lock design to allow access at both ends of the bore into which the key cylinder inserts. In addition, such a method requires that a tube type follower be inserted, which is separate from the lock assembly. Such a method requires proper timing and coordination in removal of the core and insertion of the tube to maintain the drivers captured within their respective bores. The method is prone to failure, as the drivers may fall out if the tube is not inserted properly or the timing is not coordinated with the removal of the key core so that the drivers are captured.

It can be seen that a new and improved lock apparatus and method for rekeying are needed. Such a lock should provide for automatically capturing the drivers and tumblers while the key core is removed. In addition, such a device should provide for insertion and removal of the elements from only one end of the core without requiring access from both ends, allowing for designs with one end of the bore closed. Such a lock should include rekeying elements that are integral to the lock assembly without requiring a separate tube or other special tools to capture the drivers. The present invention addresses these as well as other problems associated with rekeyable locks and rekeying methods.

### SUMMARY OF THE INVENTION

The present invention is directed to an improved lock apparatus and an improved method for rekeying the lock. The present invention has a key cylinder including a housing with a substantially cylindrical bore formed therein extending longitudinally through the housing with a portion of the body extending radially outward on a lower side of the bore. A channel extends from the top inward at approximately the midpoint of the housing transverse to the longitudinal direction. The housing also includes multiple bores formed therein extending transversely to the main bore in the body portion and intersecting the main bore. A pin assembly is housed in each of the transverse bores and includes plugs, springs and pins for engaging corresponding tumblers in the key cylinder core when inserted.

The cylinder core is substantially cylindrical and includes a lip on a first end and a slot extending through the first end of the core for receiving a key. The key is cut to include recesses at a number of varying depths along the portion inserted into the slot, commonly known as lands. The core also includes a number of bores formed therein and receives tumblers that have varying heights corresponding in number to the lands on the key. When the proper key is inserted into the core, the tumblers are pushed upward to extend just to the edge of the core and the interior surface of the main bore formed in the housing. In one embodiment, the cylinder core also includes a raised portion around the tumbler bores. An end mounting block opposite the lip and slot includes an orifice for attaching to a rotatable cam in the channel at a mid-portion of the housing. In this embodiment, the cam always rotates as the core rotates. In another embodiment, the cylinder core includes a cam engaging protrusion that engages a core engaging portion of the cam. In this embodiment, the cam does not always rotate when the core rotates. In another embodiment, an adapter extends between and engages the core and the cam.

In one embodiment, a cylindrical sleeve extends around the key cylinder and also includes an end tab with a mounting orifice for attaching to the cam. In this embodiment, the cam always rotates as the sleeve rotates. In another embodiment, the cylinder sleeve does not engage the cam, but always rotates when the core rotates. In either embodiment, the sleeve has a notch formed therein for receiving the raised portion and the tumblers. When inserted into the bore of the housing, the tumblers extend through the notch in the sleeve to engage the retainer pins of drivers in the housing. When they are properly aligned with insertion of the correct key, the tumblers and drivers meet at the same intersection as the outer surface of the sleeve and the inner surface of the housing bore, allowing rotation.

In one embodiment; the cam includes a cylindrical orifice formed therein receiving the mounting portion of the sleeve and the mounting block of the core. In another embodiment, the cam may include a shaped orifice with a core engaging portion that engages a cam engaging portion of the cylinder core. In any embodiment, the cam may also include an actuating arm for engaging the bolt or other portion of the lock assembly. The core and the sleeve may independently engage the cam so that the core may be removed from the sleeve and cam without having to also remove the sleeve. In a first embodiment of the lock apparatus, a thumb turn button is mounted to the housing at an opposite end in a similar bore. The thumb turn button includes a shaft attaching to a similar cam as the cam engaged by the core.

The present invention may also be utilized with two cylinder cores, one at each end of the housing. Each of two cylinder cores has its own set of tumblers and the housing has two sets of corresponding retainer pins. In this manner, the lock may utilize one or two keys, which may be the same or different. The present invention also provides for removing and inserting each core and sleeve through only one end of the housing. In other embodiments, the sleeve and core must be inserted and removed from opposite ends of the housing.

To rekey the lock apparatus, the key is inserted into the cylinder core so that the tumblers are pushed to the rotational boundary between the core and sleeve assembly and the core of the housing. The tumblers push the driver pins so that they are aligned and do not extend into the core and the tumblers do not extend into the housing. The key then turns the sleeve, cam and core so that the notch and tumblers are moved away from the retainer pins. The retainer pins are biased against the sleeve at this position and the drivers are captured by the sleeve within their own bores in the housing by the sleeve. The core is then detached from the cam and slid outward. The key and the tumblers are removed and a new key having different lands is inserted. New tumblers having the necessary height to extend only to the periphery of the core and the inner surface of the housing bore when engaged by the lands of the new key are inserted into the tumbler bores of the core. The core with the key inserted and the tumblers facing upward are then reinserted into the bore and sleeve and attached to the cam. The lock apparatus may then be operated with the lock configured for receiving and being actuated by the new key.

These features of novelty and various other advantages that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 shows an exploded perspective view of a first embodiment of a lock according to the principles of the present invention;

FIG. 2 shows a perspective view with portions broken away of the lock of FIG. 1;

FIG. 3 shows a side sectional view of the lock of FIG. 1;

FIG. 4 shows a perspective view of the lock of FIG. 1 with the core removed and the pins removed from the core;

FIG. 5 shows a perspective view of the lock of FIG. 1 with portions broken away and the core removed;

FIG. 6 shows a perspective view of the lock of FIG. 5 from a second end; and

FIG. 7 shows a side sectional of a second embodiment of a lock according to the principles of the present invention with the lock having two key actuated cylinder assemblies.

FIG. 8 shows an exploded perspective view of a third embodiment of a lock according to the principles of the present invention;

FIG. 9 shows a perspective view with portions broken away of the lock of FIG. 8;

FIG. 10 shows a partial rear perspective view of the lock of FIG. 8;

FIG. 11 shows an exploded perspective view of a fourth embodiment of a lock having two key cylinders according to the principles of the present invention;

FIG. 12 shows an exploded perspective view of a fifth embodiment of a lock according to the principles of the present invention;

FIG. 13 shows a side sectional of the lock of FIG. 12;

FIGS. 14A and 14B show front and rear perspective views, respectively, of the cam shown in FIG. 12; and

FIG. 15 shows a perspective view of the adapter shown in FIG. 12.

### DETAILED DESCRIPTION OF THE PREFERRED EMBODIMENT

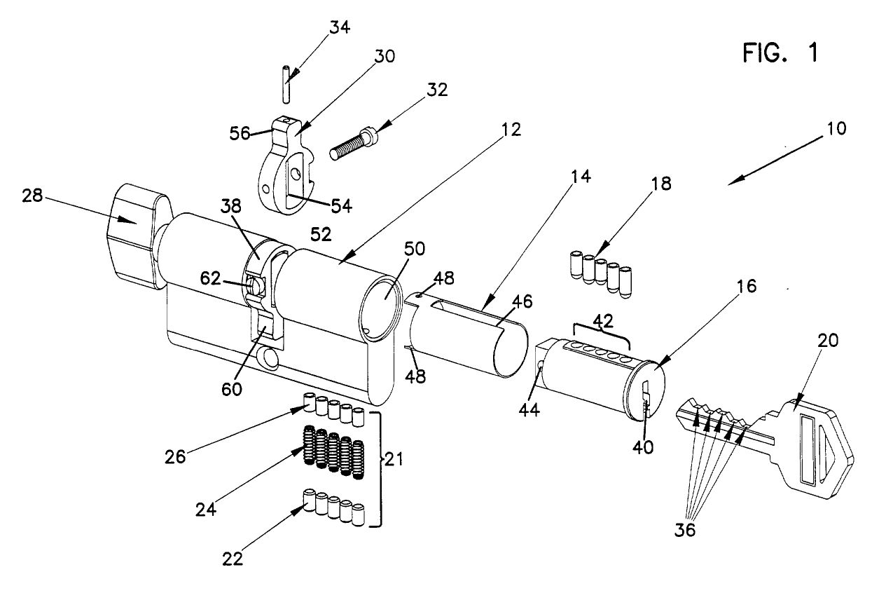

Turning now to the drawings, and in particular to FIG. 1, there is shown a portion of a first embodiment of a lock, generally designated 10. The lock includes a housing 12 having a cylindrical portion with a bore 50 formed therein and extending axially through a portion of the housing 12. The housing 12 has an enlarged cylindrical portion defining the bore 50 and a solid longitudinal portion extending radially downward from the enlarged cylindrical portion. In the embodiment shown, the lock 10 receives a core 16 actuating a first cam 30 with a thumb turn button 28 at an opposite end of the housing 12 actuating a second cam 38. As explained hereinafter, the present invention may also be configured to receive two cores to be independently actuated from each end of the lock.

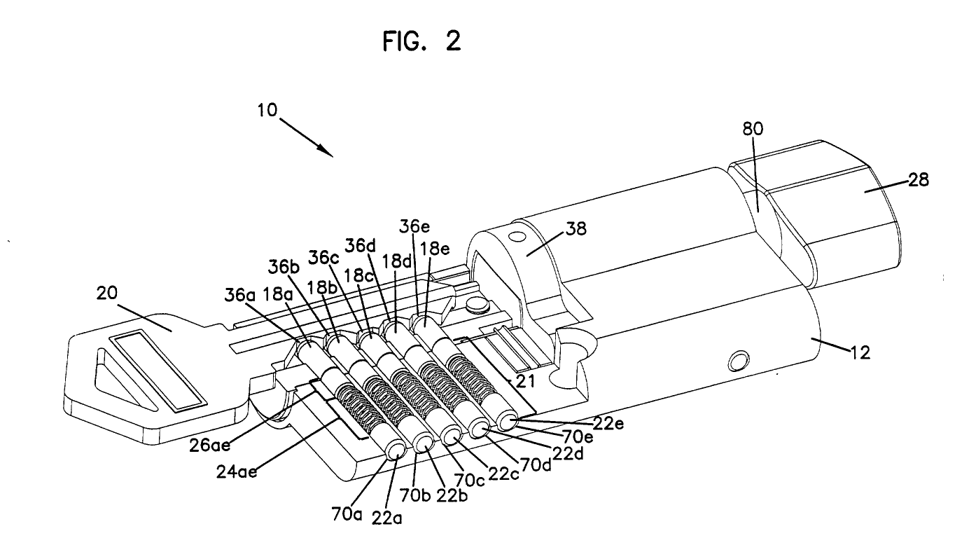

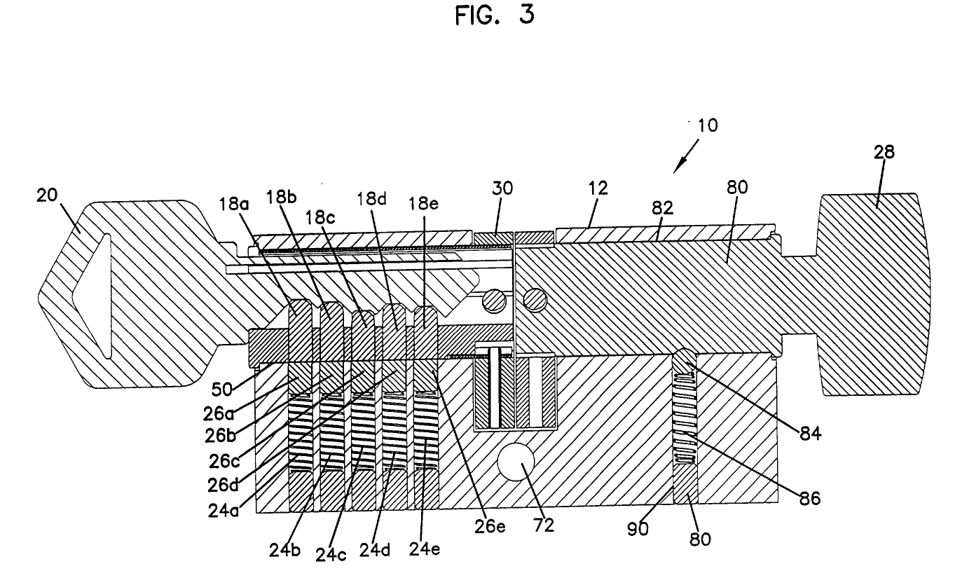

Referring now to FIGS. 1-3, the core 16 includes an end slot 40 configured for receiving a key 20. The core 16 includes an end lip extending slightly radially outward and setting against the housing 12. The key 20 has engagement surfaces commonly called lands 36 that are at different depths to form a unique pattern. The lands 36 engage complementary tumblers 18 that are matched to the depth of each corresponding land 36. The core 16 includes bores 42 for receiving the tumblers 18. The core 16 also includes a mounting block 44 opposite the end with the slot 40 and having an orifice formed therein. The mounting block 44 attaches to the cam 30, as explained hereinafter. In the embodiment shown, there are five tumblers designated 18A-E extending into five tumbler receiving bores 42. The tumblers 18 engage the five corresponding lands 36A-E. Although five sets are shown, it will be readily apparent that other configurations having more or fewer lands 36, tumblers 18 and bores 42, are also possible. When the proper key 20 is inserted into the slot 40, each of the lands 36 engage the corresponding tumbler 18 and push the tumbler to a position as shown in FIGS. 2 and 3, wherein the outer ends of the tumblers 18 extend just to the inner surface of the bore 50.

The present invention also includes a sleeve 14 having a substantially cylindrical shape inserting over the core 16 and rotatable in the bore 50. The sleeve 14 includes end tabs 48 with a mounting hole for aligning with and attaching to the first cam 30, as explained hereinafter. In addition, a longitudinal notch 46 is formed along a substantial portion of the sleeve 14 so as to align with the tumblers 18. In a preferred embodiment, the core 16 also includes a slightly raised ridge portion 17 that extends into the notch 46 of the sleeve 14 to the inner surface of bore 50.

The cam 30 has a main body portion with a substantially rectangular slot 54 for receiving the mounting block 44 of the core 16 and the tabs 48 of the sleeve 14. A cam screw 32 inserting through the walls of the cam 30 and the orifice in the mounting block 44 attach the core 16. The cam 30 also includes an arm portion 56 that engages a bolt or other device as is well know in the art (not shown), to provide actuation of the lock 10. The sleeve 14 mounts to the cam 30 with a cam spring pin 34 that extends through the cam arm 56 and into the mounting orifice formed in one of the tabs 48 on the sleeve 14 that extend into the substantially rectangular slot 54. The cams 30 and 38 are located in a channel 52 extending substantially transverse to the axial direction of the housing 12. When the lock 10 is assembled, the core 16, sleeve 14 and cam 30 are rotatably mounted in the housing 12 and rotate as a unit. It can also be appreciated that as the core 16 and sleeve 14 mount independently to the cam 30 and the sleeve slides over the core 16, the core 16 may be removed without removing the sleeve 14. This feature provides advantages for rekeying that are not possible with prior locks.

The housing 12 includes bores 70A-E for receiving pin assemblies or drivers 21. Each pin assembly 21 includes a plug 22 that retains a spring 24 and corresponding pin 26. In the embodiment shown, there are five plugs 22A-E, five springs 24A-E, and five pins 26A-E, corresponding to the five tumblers 18A-E. However, fewer or more drivers 21 may be utilized to correspond to fewer or more tumblers 18 and lands 36. As shown in FIGS. 1-3, when the correct key 20 having the matching lands 36 is inserted, the tumblers 18 push the spring loaded pins 26 so that the tumblers 18 and drivers 21 meet one another aligned at the inner surface of the bore 50 in the housing 12. At this position, the core 16 may be rotated from the locked position. The sleeve 14 is mounted with the core and the tumblers 18 extending through the notch 14 to engage the ends of the pins 26. It can be appreciated that if an incorrect key 20 is inserted into the slot 40, the lands 36 will not match up so that one or more of the tumblers 18 extend across the boundary of the core 16 and bore 50, extending into a bore 70, or one or more of the pins 26 extend into corresponding ones of the tumbler bores 42, thereby preventing the core 16 from freely rotating.

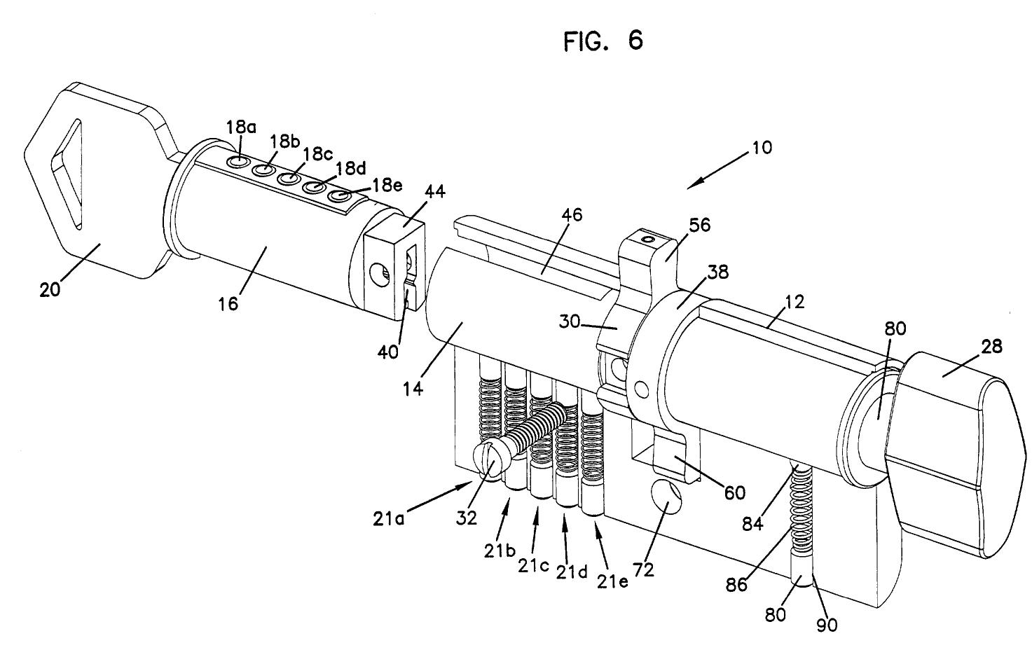

In the embodiment shown in FIGS. 1-6, a thumb turn button 28 is mounted at the opposite end of the housing 12 from the bore 50. The thumb turn 28 includes a shaft 80 extending into a longitudinal bore 82. A ball detent 84 is biased by a spring 86 against a plug 88 mounted in a channel 90 to retain the thumb turn shaft 80. The thumb turn shaft 80 mounts to the second cam 38 in a manner similar to the mounting of the core 16 to the first cam 30. A second cam screw 62 inserts into the body of the cam 38 to engage the thumb turn shaft 80. The second cam 38 includes an actuator arm 60 to engage and actuate a bolt or other mechanism (not shown). With the configuration shown in FIGS. 1-6, the key 20 and thumb turn button 28 may actuate the lock 10 independently of one another using separate cams 30 and 38. In addition, each of the bores 15 and 82 terminate in the middle of the housing 12 at the channel 52 at the mid-section of the housing 12 rather than having a bore extending entirely through the housing for inserting the sleeve in one end and a core in the opposite end. The present invention provides for insertion of the sleeve 14 and the core 16 from the same end of the bore 50. This arrangement provides for mixing and matching other types of locks such as the thumb turn button 28 or a second key actuated core, as explained hereinafter.

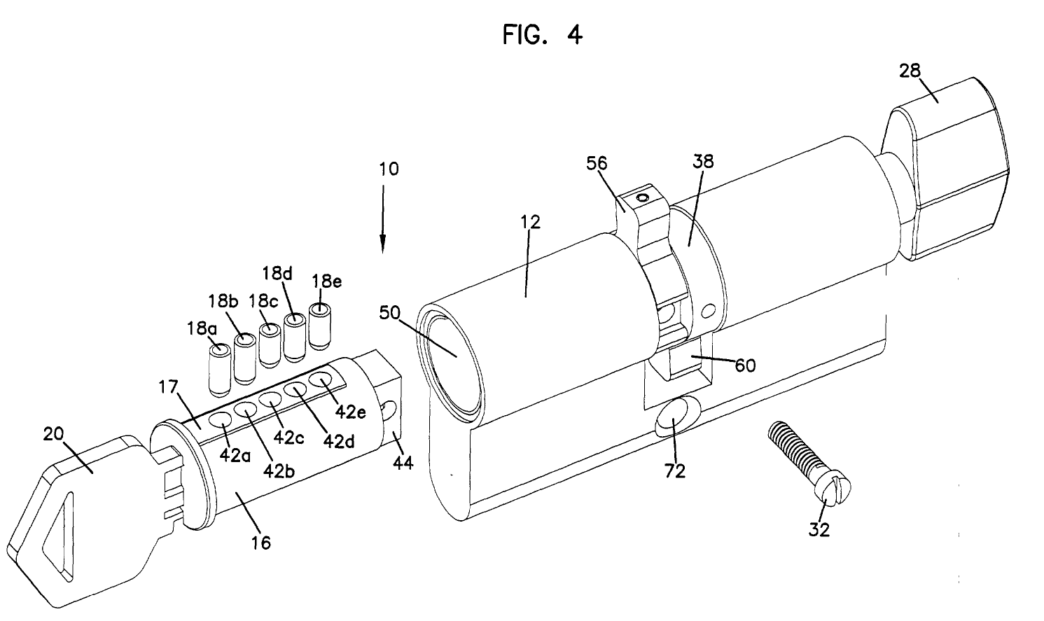

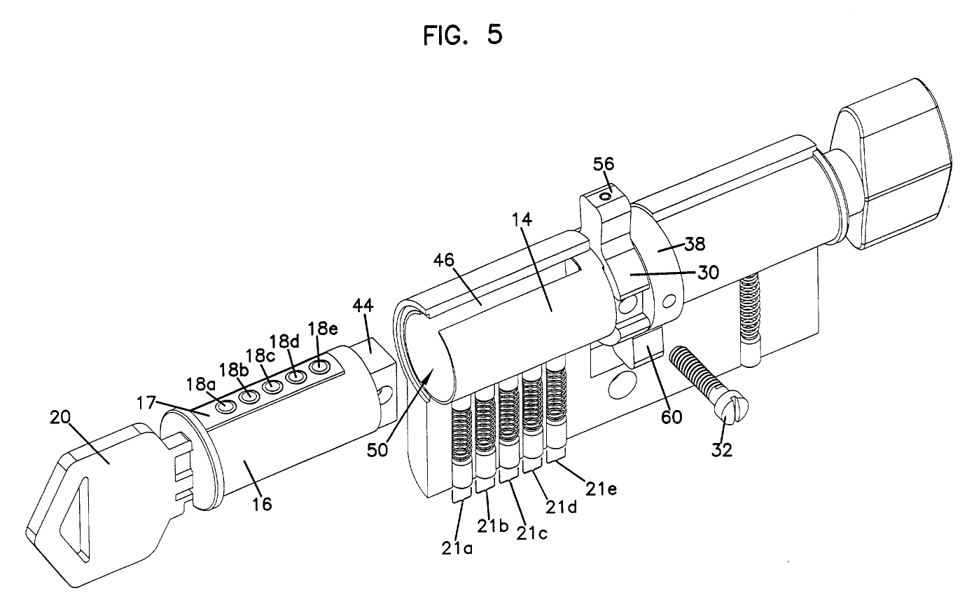

When it is desired to rekey the lock 10, the core 16 must be removed, as shown in FIGS. 4-6. To remove the core 16, the correct key 20 must be inserted into the core so that the tumblers 18 are properly aligned against the pins 26 at the outer radius of the sleeve 14. The core 16 is then rotated to an unlocked position, as shown in FIG. 5. At this position, the pins 26 engage the sleeve 14 and remain captured in the bores 70, allowing the core 16 to be removed without the springs 24 forcing the pins 26 out of the bores 70. When rotated to this position, the cam screw 32 is removed and the core 16 is slid out the end of the bore 50. With the tumbler bores 42 facing upward, the tumblers 18A-E are retained in the core 16 during removal. To rekey the core 16, the tumblers 18 are removed from the tumbler bores 42 and the key 20 is also removed. A second key 20 is then inserted having different lands 36. The lock 10 is rekeyed by inserting new tumblers 18A-E into the tumbler bores with a proper height corresponding to the depth of each land 36 such that the outermost end of the tumbler 18 extends to the inner surface of the bore 50. When the proper height tumblers 18 have been inserted into the bores 50 and are aligned, the core 16 is reinserted with the new key 20 and the new tumblers 18. The core 16 is then reattached to the first cam 30. The rekeying is complete as the new tumblers 18 meet the pins 26 at the rotational intersection of the sleeve 14 and the inner surface of the bore 50, allowing free rotation when the new key 20 is inserted.

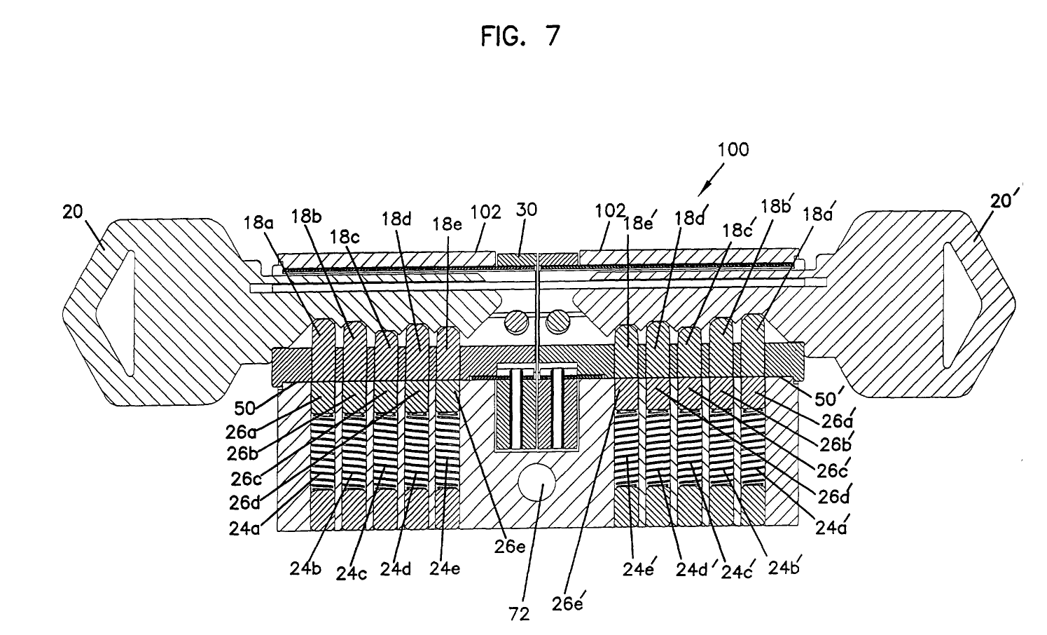

Referring now to FIG. 7, there is shown a second embodiment of a lock of the present invention, generally designated 100. The lock 100 is similar to the lock 10 except that a housing 102 receives two cylinder cores, one at each end of the housing 102, rather than a key actuated cylinder and a thumb turn button. The right hand assembly numerals are designated with a “′” throughout the drawings. The second embodiment of the lock 100 also includes a second set of pin assemblies 21′ and a second sleeve 14′. Key cylinders 16 and 16′ may be keyed identically to accommodate the same key 20 or may be keyed differently for receiving a different key 20.

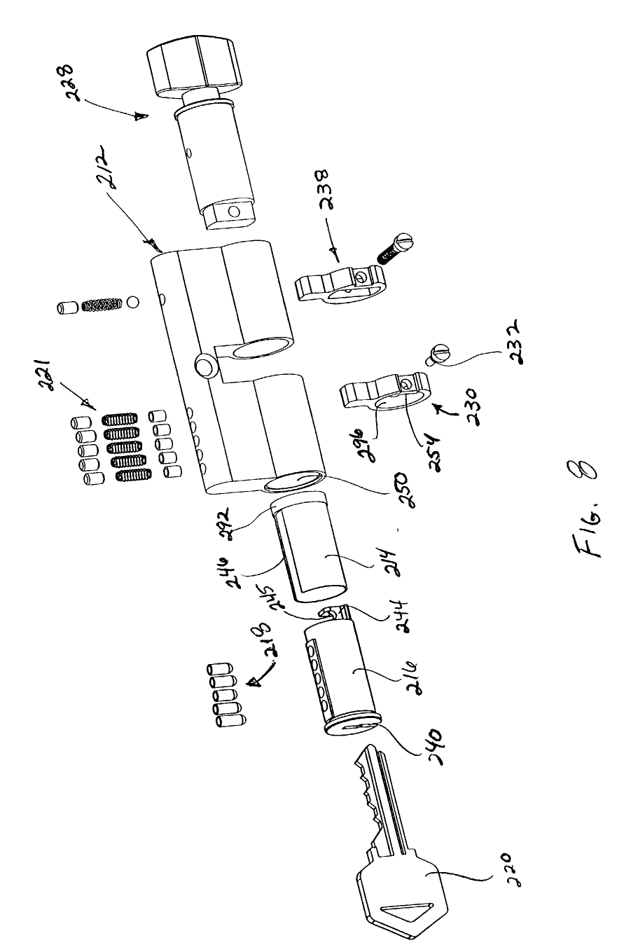

Referring now to FIGS. 8-10, there is shown a third embodiment of a lock of the present invention, generally designated 200. The lock 200 is similar to the lock 10 except that a sleeve 214 and a core 216 are not secured to a first cam 230, as required with lock 10. The lock 200 includes a housing 212 with an axially extending bore 250. Lock 200 includes a core 216 with a cam engaging protrusion 244 at an opposite end of the core 216 from an end slot 240 configured for receiving a key. The protrusion 244 engages a cam 230 when inserted into the bore 250, to rotate the cam 230 relative to the housing 212.

The sleeve 214 is rotatably mounted in the bore 250 and includes a notch 246 and a step portion 292. The notch 246 engages a ridge 217 on the core 216 so that the core and sleeve rotate together in the bore 250. The step portion 292 engages a complementary step portion 294 in the bore 250 to restrict axial movement of the sleeve 214 in the bore 250. The step portion 292 extends around the circumference of the sleeve and engages the step portion 294 that also extends around the internal circumference of the bore 250. In other embodiments, either of the step portions 292 and 294 may extend only partially around the circumference of their respective member, but should provide the necessary restriction of axial movement of the sleeve 214 in the bore 250 regardless of the rotated position of the sleeve.

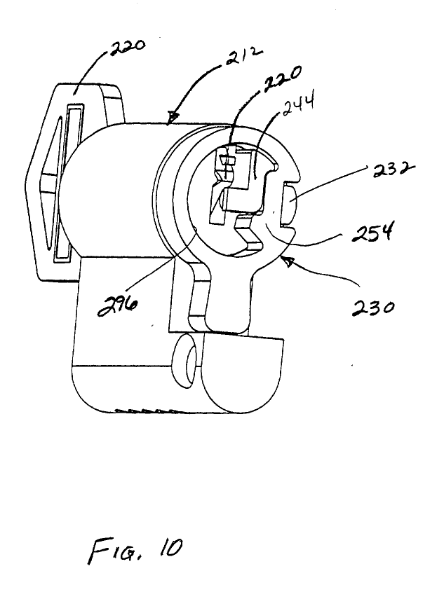

The cam 230 includes a core engaging portion 254 that receives the cam engaging protrusion 244 of the core 216 in certain rotated positions of the core. In this embodiment, the cam 230 includes an open portion 296 in which the cam engaging portion 244 rotates between a first core position and a second core position. In the first core position, shown in FIG. 10, the protrusion 244 engages the portion 254 such that rotation of the key 220 and the core 216 through a first rotation (counterclockwise) rotates the cam relative to the housing 212. If the key 220 rotates the core 216 from the first core position through a second rotation (clockwise), opposite the first rotation, the protrusion 244 rotates within the cam open portion 296 independent of the cam 230 until it again engages the core engaging portion 254 (not shown) at the second core position. Further rotation of the key 220 and the core 216 through a third rotation (clockwise) from the second core position rotates the cam 230 relative to the housing 212.

The degrees of rotation of the first, second and third rotations may vary depending on the application of the lock 200. For example, in one embodiment, the first rotation is about 230 degrees, the second rotation is about 230 degrees, and the third rotation is about 230 degrees. In another embodiment, the first rotation is about 360 degrees, the second rotation is about 180 degrees, and the third rotation is about 360 degrees.

The lock 200 also includes a cam screw 232 that engages a cam groove 245 in the cam engaging protrusion 244 when the core is in the first core position. The cam screw 232 assists in retaining the core 216 in the bore 250, for example, when the key 220 is inserted into the bore 216 and engages the tumblers 218 in the core 216 to actuate the drivers 221 in the housing 212. When the cam screw 232 is removed from the lock 200 with the key 220 inserted into the core 216 in the first core position, the core with the tumblers 218 is removable for rekeying of the lock 200.

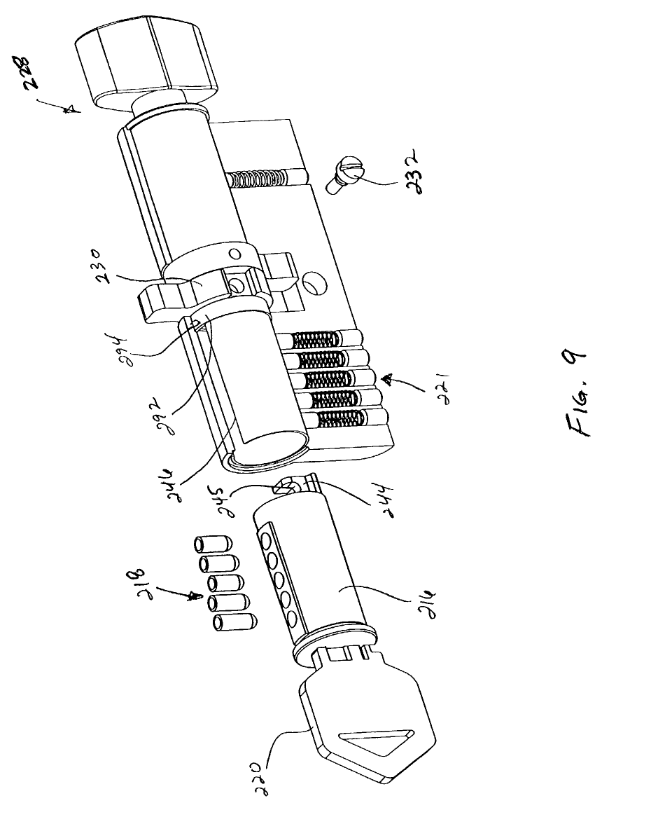

In the embodiment shown in FIGS. 8 and 9, a thumb turn button 228 is mounted at the opposite end of the housing 212 from the bore 250. Thumb turn button 228 includes the same features as thumb turn button 28 of lock 10, and actuates a second cam 238 in the same way that second cam 38 of lock 10 is actuated. In other embodiments, the button 228 may include a cam engaging protrusion similar to the cam engaging protrusion 244 of the core 216, and the second cam 238 may be configured with a core engaging portion, a cam open portion, and a cam screw similar to respective features 254, 296 and 232 of the first cam 230.

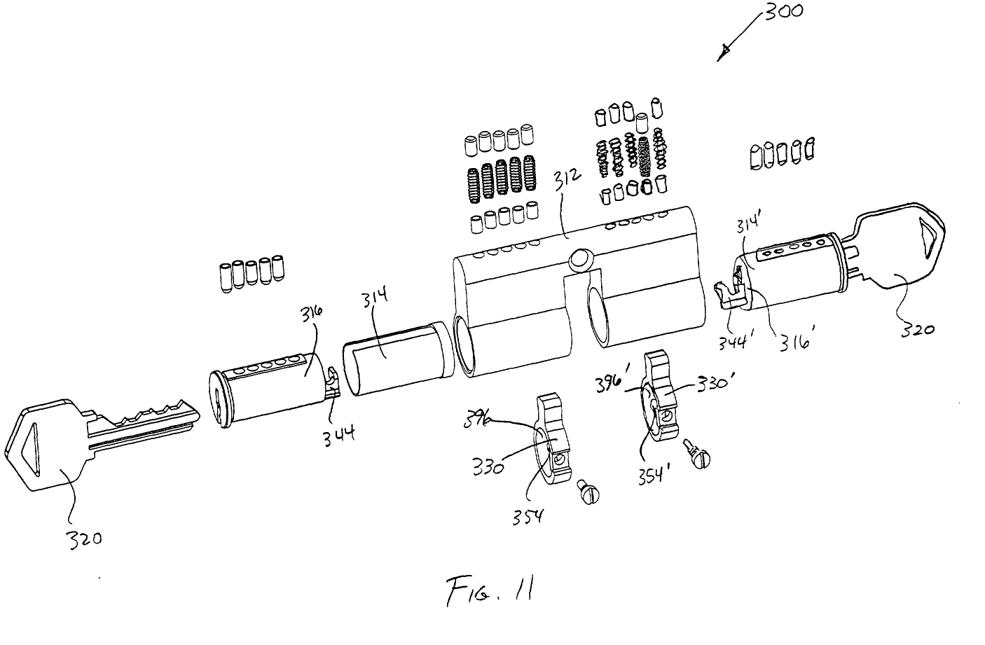

Referring now to FIG. 11, there is shown a fourth embodiment of a lock of the present invention, generally designated 300. The lock 300 is similar to the lock 200 except that a housing 312 receives two cylinder cores, one at each end of the housing 312, rather than a key actuated cylinder and a thumb turn button. The right hand assembly numerals are designated with a “′” throughout the drawings.

The lock 300 includes first and second sleeves 314 and 314′, first and second cores 316 and 316′, and first and second cams 330 and 330′ that are similar to the sleeve 214, the core 216, and the first cam 230 of the lock 200. The key cylinders 316 and 316′ may be keyed identically to accommodate the same key 320 or may be keyed differently for receiving different keys.

Preferably, the cams 330 and 330′ include similar open portions 396 and 396′ and core engaging portions 354 and 354′ to those of the cam 230. Also, the cores 316 and 316′ preferably include similar cam engaging protrusions 344 and 344′ as those of the core 216. Accordingly, the core 316 has first and second core positions (similar to those of the core 216), and the cam 330 and the core 316 engage through first and third rotations, while the core 316 does not engage the cam 330 through a second rotation, between the first and second core positions. Further, the core 316′ has third and fourth core positions (similar to the first and second core positions of the core 316), and the core 316′ and the cam 330′ engage through fourth and fifth rotations, while the core 316′ does not engage the cam 330′ through a sixth rotation, between the third and fourth core positions.

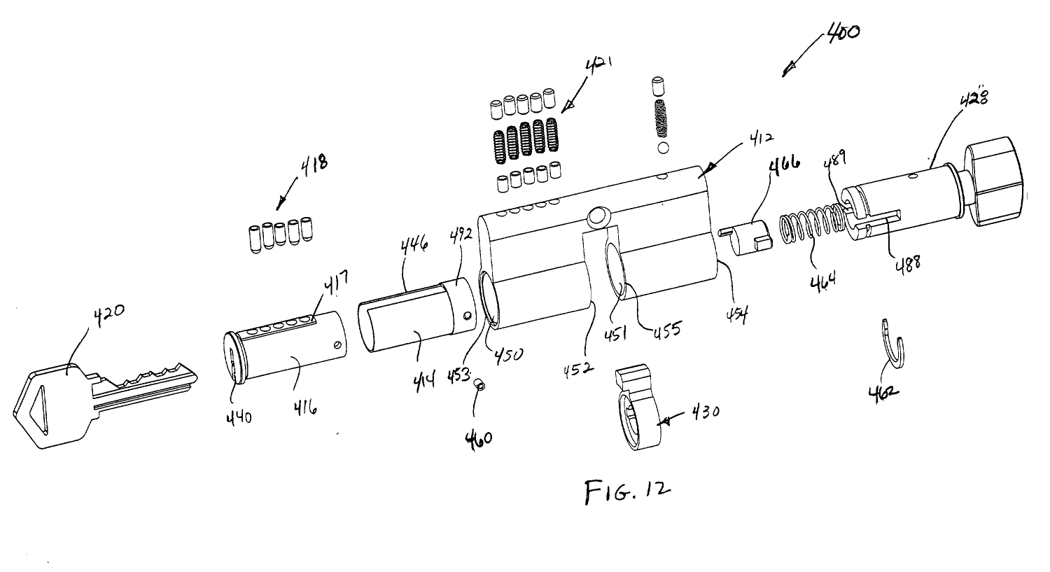

Referring now to FIGS. 12-15, there is shown a fifth embodiment of a lock of the present invention, generally designated 400. The lock 400 includes a housing 412 with first and second axially extending bores 450, 451, a sleeve 414, a core 416, and a cam 430. The lock 400 is similar to locks 10 and 200 except that sleeve 414 and core 416 are not secured to the cam 430, and the sleeve 414 and the core 416 are inserted into the bores 450 and 451 at opposite ends of the housing 412.

The lock 400 also includes tumblers 418, a key 420, drivers 421, thumb turn cylindrical core 428, set screw 460, retaining ring 462, biasing member 464 and adapter 466. The first bore 450 has first and second ends 452, 453, and the second bore 451 has first and second ends 454, 455.

The sleeve 414 is rotatably mounted in the first bore 450 by being inserted through the second bore 451 into the first end 452 of the first bore 450. The sleeve 414 includes a collar 492 or other feature that engages a counter bore or similar type feature (not shown) in the first bore 450 to restrict axial movement of the sleeve 414 out of the first bore through the first bore second end 453. The sleeve 414 also includes a notch 446 sized to engage a ridge 417 on core 416 so that the core and sleeve rotate together in bore 450. A setscrew 460 may be used to secure the sleeve 414 and the core 416 together.

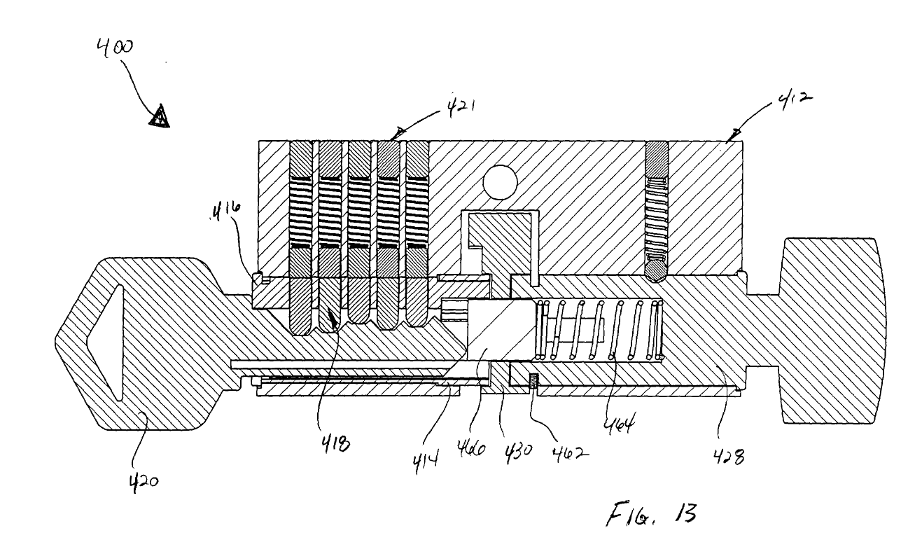

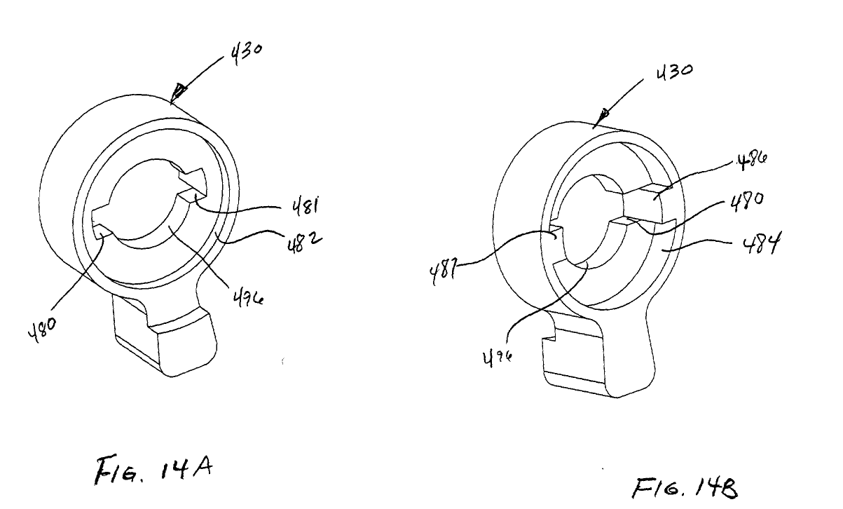

Referring to the side cross section of FIG. 13, the adapter 466 is shown engaging an end of the key 420, an end of the thumb turn core 428, and the cam 430. The cam 430, further shown in FIGS. 14A and 14B, includes an open portion 496 with side opening 480, 481 in which the adapter 466 may be inserted. The cam 430 also includes a first recessed portion 482 configured to receive ends of the sleeve 414 and the core 416, and a second recessed portion 484 configured to receive an end of the thumb turn core 428. The protrusions 486, 487, positioned in the second recess 484, are configured to engage the slots 488, 489 formed in the thumb turn core 428. The retaining ring 462 holds the thumb turn core 428 within the second core 451, thereby also retaining the cam 430 and the sleeve 414 in the housing 412.

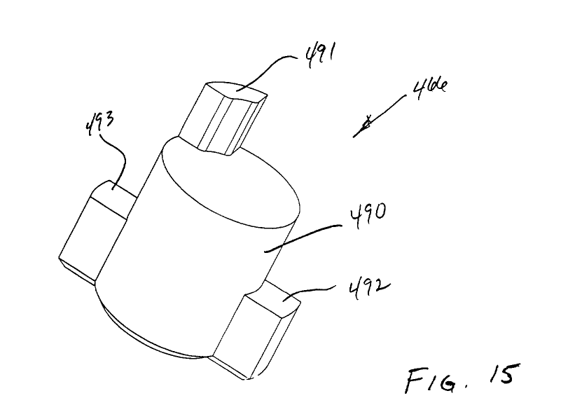

The adapter 466, shown in FIG. 15, includes a core 490, a core protrusion 491, and side protrusions 492, 493. The core protrusion 491 is capable of being inserted into of core 416 to be engaged by key 420 (see FIG. 13). When the key 420 is turned (while inserted in the core 416), the key engages the core protrusion 491, thereby rotating the side protrusions 492 and 493 of the adapter 466. Rotation of the protrusions 492 and 493 causes the cam 430 to rotate. To ensure proper positioning of the core protrusion 491 within the core 416, the adapter 466 is biased towards the core 416 by the biasing member 464.

Thus, according to the lock embodiment 400 shown in FIGS. 12-15, the cam 430 may be rotated via the adapter 466 by rotating either the core 416 or by rotating the thumb turn core 428.

Steps of a method of assembling the lock 400 include providing a housing having a first cylindrical bore formed therein with first and second open ends, providing a first cylindrical sleeve having a notch formed therein, and providing a first cylindrical core. Further steps include inserting the sleeve into the housing through the first bore end, inserting the core into the sleeve through the second bore end, the core engaging the notch of the sleeve, and securing the core and sleeve to one another.

It can be appreciated that the present invention provides for insertion and removal of the key cylinder while the drivers remain captured and while providing for insertion and removal of the core through one exposed end of the bore in the housing. The present invention overcomes the problems associated with removing cores and the limitations of the prior art requiring access to both ends of the core for rekeying of the core. The present invention also provides for an improved method of rekeying through one end of the bore while retaining the drivers without requiring a separate tube or any other special tools and without requiring coordination between sliding the core and a separate tube.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A rekeyable lock, comprising:
a housing having a cylindrical bore formed therein;
a cam rotatably mounted in the housing;
a cylindrical sleeve having a notch formed therein rotatably mounted in the bore of the housing to the cam;
a cylinder core inserting into the sleeve and engaging the cam, the core including a plurality of tumblers;
a plurality of drivers in the housing biased toward the bore.

2. A lock according to claim 1, wherein the notch extends longitudinally along the sleeve.

3. A lock according to claim 1, wherein the tumblers and the drivers align along the periphery of the bore when a proper key is inserted.

4. A lock according to claim 3, wherein the drivers extend through the notch in a locked position.

5. A lock according to claim 1, wherein the cam includes an arm.

6. A lock according to claim 1, further comprising a thumb turn button and a second cam.

7. A lock according to claim 1, wherein the core defines a slot at a first end for receiving a key.

8. A lock according to claim 1, wherein the cylinder core is mounted to the cam.

9. A lock according to claim 1, wherein the lock housing includes a transverse channel at substantially a mid-portion of the housing.

10. A lock according to claim 1, wherein the lock housing includes a first bore receiving a first key cylinder at a first end and a second bore receiving a second key cylinder at a second end.

11. A lock apparatus, comprising:
a key;
a key cylinder including:
a core having a key slot configured for receiving the key, the cylinder including at least one tumbler;
a housing having a bore receiving the core, and at least one driver aligned with the at least one tumbler and biased toward the tumbler, wherein the core is rotatably mounted in the housing;
a sleeve fitting onto the core and rotatably mounted in the bore, wherein the sleeve has a notch formed therein.

12. A lock apparatus according to claim 11, wherein the notch is aligned with the at least one driver and the at least one tumbler in a locked position.

13. A lock apparatus according to claim 11, wherein the tumbler and driver are substantially transverse to the key slot.

14. A lock apparatus according to claim 11, further comprising a first cam coupled to the core.

15. A lock apparatus according to claim 14, further comprising a second cam rotatably mounted in the housing.

16. A lock apparatus according to claim 15, further comprising a thumb turn button mounted to the second cam.

17. A lock apparatus according to claim 16, further comprising a bolt actuated by the first cam or the second cam

18. A lock apparatus according to claim 10, wherein the bore and the sleeve are cylindrical.

19. A lock apparatus, comprising:
a housing having a cylindrical bore formed therein;
a cylindrical sleeve having a notch formed therein rotatably mounted in the bore of the housing;
a cylinder core inserting into the sleeve, the core including at least one tumbler;
at least one driver mounted in the housing and biased toward the bore.

20. The lock apparatus of claim 19 wherein the cylindrical bore comprises a step portion, and the cylindrical sleeve comprises a step portion, the sleeve step portion engaging the bore step portion to limit axial motion of the sleeve in the bore.

21. The lock apparatus of claim 19 further comprising a cam, wherein the core rotates in the bore independent of the cam through a second rotation and engages the cam through a first rotation and a third rotation.

22. The lock apparatus of claim 21 wherein the first rotation is about 230 degrees, the second rotation is about 230 degrees, and the third rotation is about 230 degrees.

23. A method of rekeying a lock, the lock having a cylinder housing with a bore formed therein and a plurality of drivers positioned proximate the bore and biased toward the bore; a core rotatably mounted in the bore and having a slot receiving keys, and a plurality of first tumbler pins engaging a first key; a sleeve having a notch formed therein rotatably mounted in the bore over the core; wherein the drivers and first tumbler pins engage one another through the notch in a first position; and a cam attaching to the sleeve and the core; the method comprising the steps of:
rotating the core one half turn from the first position, thereby rotating the cam and the sleeve one half turn such that the sleeve covers the tumblers;
detaching the core from the cam;
sliding the core from the bore;
removing the first key and the first pins from the core;
inserting a second key and second pins into the core such that ends of the second pins are aligned with a periphery of the core;
inserting the core in the bore such that the second pins align with the notch; and
attaching the core to the cam.

24. A lock apparatus, comprising:
a housing having a cylindrical bore formed therein having an open first end;
a cylindrical sleeve having a notch formed therein rotatably mounted in the bore of the housing and insertable in the first end of the bore;
a cylinder core inserting into the sleeve in the first end of the bore, the core including a plurality of tumblers;
a plurality of drivers in the housing biased toward the bore.

25. A lock apparatus, comprising:
a housing having a cylindrical bore formed therein;
a cam rotatably mounted in the housing;
a cylindrical sleeve rotatably mounted in the housing bore; and
a cylinder core inserting into the sleeve and rotatably mounted in the bore;
wherein the core rotates in the housing independent of the cam through a second rotation, and the core engages the cam through a first rotation and a third rotation.

26. The lock apparatus of claim 25 wherein the cylindrical sleeve comprises a step portion and the housing bore comprises a step portion, the sleeve step portion engaging the bore step portion to limit rotation of the sleeve within the housing bore.

27. The lock apparatus of claim 25 wherein the core comprises a cam engaging protrusion, the cam engaging protrusion capable of engaging the cam through the second rotation to rotate the cam relative to the housing.

28. The lock apparatus of claim 25 wherein the first rotation is about 230 degrees, the second rotation is about 230 degrees, and the third rotation is about 230 degrees.

29. The lock apparatus of claim 25 wherein the sleeve comprises a notch and the core comprises a raised portion, the core raised portion engaging the sleeve slot.

30. The lock apparatus of claim 27 wherein the cam comprises a core engaging protrusion, the core engaging portion engaging the cam engaging protrusion of the core through the second rotation.

31. The lock apparatus of claim 30 wherein the core engaging portion comprises a fastener removably inserted through an aperture in the cam.

32. The lock apparatus of claim 25 wherein the cam retains the core within the housing bore when a key inserted in the key cylinder is capable of being removed from the key cylinder.

33. The lock apparatus of claim 25 further comprising a second core formed in the housing, and a second cam rotatably mounted in the housing.

34. The lock apparatus of claim 33 further comprising a thumb turn button core insertable into the second bore and secured to the second cam.

35. The lock apparatus of claim 33 further comprising a second key cylinder, comprising:
a second cylindrical sleeve rotatably mounted in the second housing bore;
a second cylinder core inserting into the second sleeve and rotatably mounted in the second bore, the second core including a plurality of tumblers; and
a plurality of drivers in the housing biased toward the second bore;
wherein the second core rotates in the housing independent of the second cam through a fifth rotation, and the second core engages the second cam through a fourth rotation and a sixth rotation.

36. A rekeyable lock, comprising:
a housing having a first cylindrical bore formed therein having an open first end and an open second end;
a cylindrical sleeve having a notch formed therein rotatably mounted in the bore of the housing and insertable in the second end of the bore; and
a cylindrical core insertable into the sleeve through the first end of the bore, the core having a raised portion engaging the notch in the sleeve.

37. The lock of claim 36 further comprising a cam, wherein the core engages the cam to rotate the cam.

38. The lock of claim 36 wherein the sleeve comprises a collar and the bore includes a recessed portion for engaging the collar.

39. The lock of claim 36 wherein the core and the sleeve are secured together with a fastener.

40. The lock of claim 36 further comprising a second cylindrical bore having a first open end, and a second cylindrical core, wherein the second bore is capable of receiving the second cylindrical core.

41. The lock of claim 40 wherein the second cylindrical core engages the cam to rotate the cam.

42. The lock of claim 40 wherein the second cylindrical core is secured in the second bore with a fastener.

43. A method of assembling a rekeyable lock, the method comprising the steps of:
providing a housing having a first cylindrical bore formed therein including first and second open ends, a first cylindrical sleeve having a notch formed therein, and a first cylindrical core;
inserting the sleeve into the housing through the first bore end;
inserting the core into the sleeve through the second bore end, the core engaging the notch of the sleeve; and
securing the core and sleeve to one another.

44. The method of claim 43 wherein the providing step further comprises a second cylindrical bore having a first open end, and a second cylindrical core insertable into the second bore through the first end of the second bore.

45. The method of claim 44 wherein the providing step further comprises a rotatable cam whereby the cam is mounting, the cam to the housing between the first and second bores, the cam being engaged by the first and second cores to rotate the cam.

46. The method of claim 44 wherein the first core is a key cylinder and the second core is a thumb turn cylinder.
